(19) United States
(12) Patent Application Publication
(10) Pub. No.: US 2022/0139239 A1
(43) Pub. Date: May 5, 2022

(54) METHOD AND APPARATUS FOR PREDICTING UNSAFE APPROACH

(71) Applicant: Electronics and Telecommunications Research Institute, Daejeon (KR)

(72) Inventors: Deock Gu JEE, Daejeon (KR); Ji Yeon KIM, Daejeon (KR); Noh Sam PARK, Sejong-si (KR)

(21) Appl. No.: 17/505,144

(22) Filed: Oct. 19, 2021

(30) Foreign Application Priority Data
Nov. 4, 2020 (KR) 10-2020-0146406

(51) Int. Cl. G08G 5/02; G08G 5/00; B64D 45/00

(52) U.S. Cl. CPC G08G 5/02; G08G 5/003; B64D 2045/008; B64D 45/00; G08G 5/0004

(57) ABSTRACT

Provided is a method of predicting an unsafe approach during an approach phase of a flight. The method includes: receiving static flight metadata related to the flight from an external server; extracting a flight data recorder (FDR) data set of the aircraft for a safe approach to a destination of the aircraft from history data of flights of the aircraft to the destination stored in advance; selecting parameters related to unsafe approaches based on the static flight metadata and the FDR data set; extracting time series data for the FDR data set taking into account the parameters related to the unsafe approaches; selecting an event variable to be used for an unsafe approach determination based on the time series data; generating final prediction data by weighting the time series data for the event variable; and determining whether an unsafe approach is predicted or not based on the final prediction data.

### CROSS-REFERENCE TO RELATED APPLICATION

The present application claims a convention priority to Korean Patent Application No. 10-2020-0146406 filed on Nov. 4, 2020, with the Korean Intellectual Property Office (KIPO), the entire content of which is incorporated herein by reference.

### BACKGROUND

### 1. Technical Field

The present disclosure relates to a method and apparatus for predicting an unsafe approach during an approach phase of a flight and, more particularly, to a method and apparatus for predicting the unsafe approach using deep learning.

### 2. Description of Related Art

Various types of aviation safety-related data are being collected and stored after being classified into a safety field, an airline field, an airport field, a flight field, and other fields. The safety field data may include data related to aviation accidents, quasi-accidents, and reported safety failures, data related to integrated aviation safety information, and data related to aviation information technologies. An aviation accident investigation report aims to identify the cause of an accident and prevent similar accidents in the future. Meanwhile, big data in the airport field may include flight record-related data.

Some countries are integrating the aviation safety-related data step by step and building aviation safety big data to enable to analyze the aviation safety big data and derive safety indicators to be used to prevent the aviation accidents. In addition, it is expected that the analysis of the aviation safety big data can be utilized for a real-time prediction of a possibility of the safety accident.

A typical example of collecting and analyzing the flight record-related data is a Flight Operational Quality Assurance (FOQA) program. The FOQA program, which is a program that aims to reduce defects affecting the aviation safety and prevent accidents during a flight through data analyses, collects flight parameters including various sensor data over an entire flight through a Flight Data Recorder (FDR) such as an aircraft condition monitoring system (ACMS). FDR data is objective and quantitative data about various events that may occur during the flight, and the analysis of the FDR data enables to detect risk factors through a correlation analysis between an accident rate and usual flight data. The risk factors may be used as preliminary indicators of the aircraft safety accidents and may be used to prevent the aircraft accidents.

The FOQA program categorizes an approach phase of a flight phase into a safe approach and an unsafe approach. The safe approach means a case where a heading and pitch of the aircraft are within small tolerances, and the aircraft is on a correct path with a proper speed and a proper landing configuration. The unsafe approach means a case where a rate of descent, an airspeed, a glide slope, or localizer parameter exceeds a preset limit. The unsafe approach may result in an accident such as a hard landing, a runway departure, a landing short of runway, and a controlled flight into terrain (CFIT). The aircraft has to immediately turn around when an unsafe approach is probable at 500 feet or 1,000 feet above ground level (AGL), but there is a problem that a definition of and criterion for the unsafe approach may be ambiguous for the pilots.

An analysis of accidents of commercial airlines worldwide from 2005 to 2014 revealed that 32% of fatal accidents occurred during the approach phase and 24% occurred during a landing phase. Thus, it is necessary to predict the unsafe approach and provide the pilot with information on the unsafe approach sufficiently early so that the pilot can take necessary actions to prevent a possible accident. Exemplary trials for enhancing a precision of the unsafe approach prediction include a prediction of an aircraft path by simply applying a position and rate of change of the aircraft to a kinematic model, taking into account uncertainties due to weather information and human factors, and comprehensively considering extrinsic parameters such as aircraft configurations (e.g. a flap and slat of the aircraft) and air traffic controls.

### SUMMARY

To solve the problems above, provided is a method and apparatus for precisely predicting an unsafe approach that may cause an aircraft accident during an approach phase of a flight.

According to an aspect of an exemplary embodiment, provided is a method of predicting an unsafe approach during an approach phase of a flight. The unsafe approach prediction method includes: receiving static flight metadata related to the flight from an external server; extracting a flight data recorder (FDR) data set of the aircraft for a safe approach to a destination of the aircraft from history data of flights of the aircraft to the destination stored in advance; selecting parameters related to unsafe approaches based on the static flight metadata and the FDR data set; extracting time series data for the FDR data set taking into account the parameters related to the unsafe approaches; selecting an event variable to be used for an unsafe approach determination based on the time series data; generating final prediction data by weighting the time series data for the event variable; and determining whether an unsafe approach is predicted or not based on the final prediction data.

The static flight metadata may include at least one of weather information, aircraft type information, a departure, a destination, a stopover, a flight distance, an expected arrival time, air traffic control (ATC) information, or captain information of the flight.

The FDR data set may include a preset number of past FDR data sets and a preset number of future FDR data sets on a basis of a current time for the aircraft.

The operation of selecting parameters related to unsafe approaches may include: calculating probabilities of parameters corresponding to importance of respective one of the parameters related to the unsafe approaches by using a softmax function; and selecting the parameters that are expected to be related with the unsafe approaches based on the probabilities.

The event variable may include at least one of heading and pitch, a speed, a configuration, a descent rate, an airspeed, a glide slope, a latitude, a longitude, or an altitude of the aircraft.

The operation of determining whether an unsafe approach is predicted or not may include determining whether the unsafe approach is predicted or not at a predetermined timing. The predetermined timing may include a time when the aircraft is at 500 feet or 1,000 feet above ground level.

According to an aspect of an exemplary embodiment, provided is an apparatus for predicting an unsafe approach during an approach phase of a flight. The unsafe approach prediction apparatus includes a processor and a memory storing at least one instruction to be executed by the processor. The at least one instruction when executed by the processor causes the processor to: receive static flight metadata related to the flight from an external server; extract a flight data recorder (FDR) data set of the aircraft for a safe approach to a destination of the aircraft from history data of flights of the aircraft to the destination stored in advance; select parameters related to unsafe approaches based on the static flight metadata and the FDR data set; extract time series data for the FDR data set taking into account the parameters related to the unsafe approaches; select an event variable to be used for an unsafe approach determination based on the time series data; generate final prediction data by weighting the time series data for the event variable; and determine whether an unsafe approach is predicted or not based on the final prediction data.

The static flight metadata may include at least one of weather information, aircraft type information, a departure, a destination, a stopover, a flight distance, an expected arrival time, air traffic control (ATC) information, or captain information of the flight.

The FDR data set may include a preset number of past FDR data sets and a preset number of future FDR data sets on a basis of a current time for the aircraft.

The instruction that causes the processor to select parameters related to unsafe approaches may include instructions causing the processor to calculate probabilities of parameters corresponding to importance of respective one of the parameters related to the unsafe approaches by using a softmax function, and select the parameters that are expected to be related with the unsafe approaches based on the probabilities.

The event variable may include at least one of heading and pitch, a speed, a configuration, a descent rate, an airspeed, a glide slope, a latitude, a longitude, or an altitude of the aircraft.

The instruction that causes the processor to determine whether an unsafe approach is predicted or not may include instructions causing the processor to determine whether the unsafe approach is predicted or not at a predetermined timing. The predetermined timing may include a time when the aircraft is at 500 feet or 1,000 feet above the ground level.

According to an exemplary embodiment of the present disclosure, a deep learning network that selects parameters related to the unsafe approaches is used and it is possible to analyze a correlation between a prediction result and the parameters. Also, the use of the static data may enhance the precision of the prediction. The use of known future data as a part of input data to the FDR data prediction model may further enhance the precision of the prediction.

### BRIEF DESCRIPTION OF THE DRAWINGS

In order that the disclosure may be well understood, there will now be described various forms thereof, given by way of example, reference being made to the accompanying drawings, in which:

FIG. 1 is a flowchart showing an unsafe approach prediction method according to an exemplary embodiment of the present disclosure;

FIG. 2 is a functional block diagram of an unsafe approach prediction apparatus according to an exemplary embodiment of the present disclosure;

FIG. 3 is a detailed block diagram of the unsafe approach prediction apparatus shown I FIG. 2;

FIG. 4 is a detailed block diagram of a metadata receiving unit;

FIG. 5 is a detailed block diagram of a FDR data extraction unit; and

FIG. 6 is a physical block diagram of the unsafe approach prediction apparatus according to an exemplary embodiment of the present disclosure.

The drawings described herein are for illustration purposes only and are not intended to limit the scope of the present disclosure in any way.

### DETAILED DESCRIPTION

For a more clear understanding of the features and advantages of the present disclosure, exemplary embodiments of the present disclosure will be described in detail with reference to the accompanied drawings. However, it should be understood that the present disclosure is not limited to particular embodiments disclosed herein but includes all modifications, equivalents, and alternatives falling within the spirit and scope of the present disclosure. In the drawings, similar or corresponding components may be designated by the same or similar reference numerals.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” may include a presence of one or more of the associated listed items and any and all combinations of the listed items.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Exemplary embodiments of the present disclosure will now be described in detail with reference to the accompanying drawings.

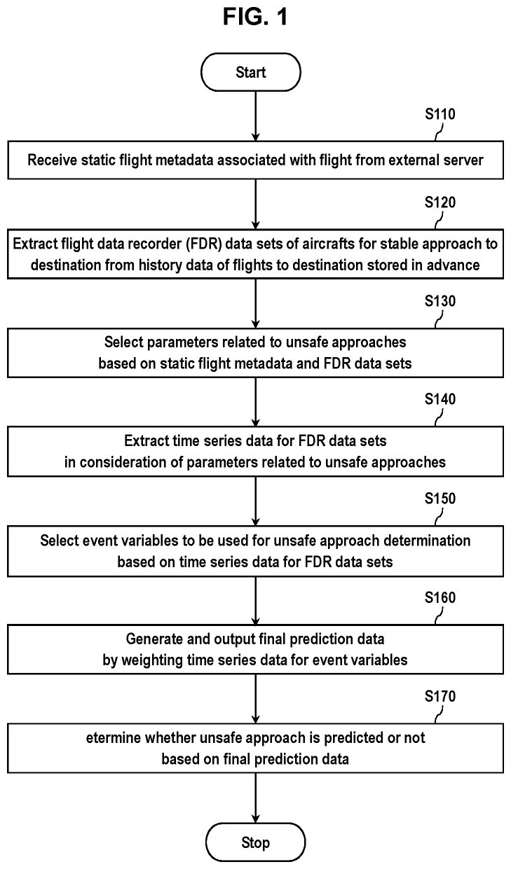

FIG. 1 is a flowchart showing an unsafe approach prediction method according to an exemplary embodiment of the present disclosure. The unsafe approach prediction method may be used to predict an unsafe approach during an approach phase of a flight.

In an operation S110, static flight metadata associated with the flight may be received from an external server. The static flight metadata may include at least one of weather information, aircraft type information, a departure, a destination, a stopover, a flight distance, an expected arrival time, air traffic control (ATC) information, or captain information of each flight.

In operation S120, a flight data recorder (FDR) data set of the aircraft for a safe approach to the destination may be extracted from history data of flights of the aircraft to the destination stored in advance. The FDR data set may include a preset number of past FDR data sets and a preset number of future FDR data sets on a basis of a current time for the aircraft.

In operation S130, parameters related to unsafe approaches may be selected based on the static flight metadata and the FDR data set. To this end, probabilities of parameters corresponding to the importance of respective parameters related to the unsafe approaches may be calculated by using a softmax function, and then the parameters of highest probabilities that are expected to be related with the unsafe approaches may be selected based on the probabilities.

In operation S140, time series data for the FDR data set may be extracted taking into account the parameters related to the unsafe approaches.

In operation S150, an event variable to be used for an unsafe approach determination may be selected based on the time series data for the FDR data set. The event variable may include at least one of heading and pitch, a speed, a configuration, a descent rate, an airspeed, a glide slope, a latitude, a longitude, or an altitude of the aircraft.

In operation S160, final prediction data may be generated and output by weighting the time series data for the event variable.

In operation S170, it may be determined whether the unsafe approach is predicted or not based on the final prediction data. The determination of whether the unsafe approach is predicted or not may be made at a predetermined timing. The predetermined timing may include a time when the aircraft is at 500 feet or 1,000 feet above ground level.

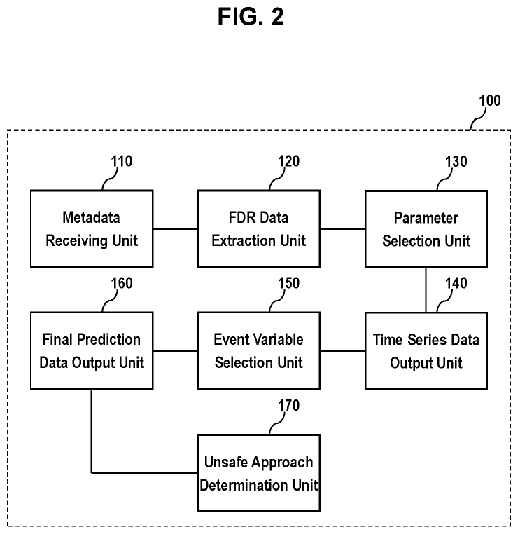

FIG. 2 is a functional block diagram of an unsafe approach prediction apparatus according to an exemplary embodiment of the present disclosure. The unsafe approach prediction apparatus 100 according to an exemplary embodiment of the present disclosure may include a metadata receiving unit 110, an FDR data extraction unit 120, a parameter selection unit 130, a time series data output unit 140, an event variable selection unit 150, a final prediction data output unit 160, and an unsafe approach determination unit 170.

The metadata receiving unit 110 may receive the static flight metadata associated with the flight from the external server. The external server may be the NASA open data portal providing open-data to the public and operated by National Aeronautics and Space Administration (NASA). Alternatively, the external server may be a server storing a number of data recorded by FDRs or another server storing sensing data related to the flight records. The metadata receiving unit 110 may receive the static flight metadata and output static latent variables. The static flight metadata may include at least one of the weather information, the aircraft type information, the departure, the destination, the stopover, the flight distance, the expected arrival time, the ATC information, or the captain information of each flight.

The FDR data extraction unit 120 may extract the FDR data set of the aircraft by using the history data of the flights to the destination of the aircraft stored in advance in the unsafe approach prediction apparatus. The FDR data set extracted by the FDR data extraction unit 120 may include the flight history data associated with safe approach flights of the aircraft to the destination and the flight history data associated with unsafe approach flights of the aircraft to the destination. The FDR data set may include a preset number of the past FDR data sets and a preset number of the future FDR data sets on a basis of the current time for the aircraft. For example, the FDR data extraction unit 120 may extract the FDR data set of an M-second interval in the future that is expected to be needed for the safe approach to the destination of the aircraft, and the FDR data set of the M-second interval in the future may be stored in advance in the unsafe approach prediction apparatus.

The parameter selection unit 130 may select parameters related to the unsafe approaches based on the received static flight metadata and the extracted FDR data set. That is, the parameter selection unit 130 may select m parameters related to the unsafe approaches from among lots parameters recorded by the FDR. The number of parameters, m, may be preset by a user. For example, the FDR data provided by the NASA public data portal may include data samples containing a total of 186 parameters gathered by sensors during flights of the aircrafts, and the parameter selection unit 130 may select the m parameters related to the unsafe approaches from the 186 parameters.

The time series data output unit 140 may extract the time series data for the FDR data set taking into account the m parameters selected by the parameter selection unit 130. That is, the time series data output unit 140 may extract the future data for the FDR data set taking into account each of the parameters related to the unsafe approaches.

The event variable selection unit 150 may select the event variable to be used for the unsafe approach determination based on the time series data extracted by the time series data output unit 140. The event variable may include at least one of the heading and pitch, the speed, the configuration, the descent rate, the airspeed, the glide slope, the latitude, the longitude, or the altitude of the aircraft, which may belong to the criteria for the unsafe approach defined in the Flight Operational Quality Assurance (FOQA) program.

The final prediction data output unit 160 may generate and output the final prediction data by weighting the time series data for the event variable.

The unsafe approach determination unit 170 may determine whether the unsafe approach is predicted for a current flight or not based on the final prediction data output by the final prediction data output unit 160. For example, the unsafe approach determination unit 170 may perform a post-processing of the final prediction data, sample the final prediction data at a critical timing corresponding to a value of a specific event variable, and determine the unsafe approach. The critical timing may be a predetermined timing such as a timing when the aircraft is at 500 feet or 1,000 feet above the ground level.

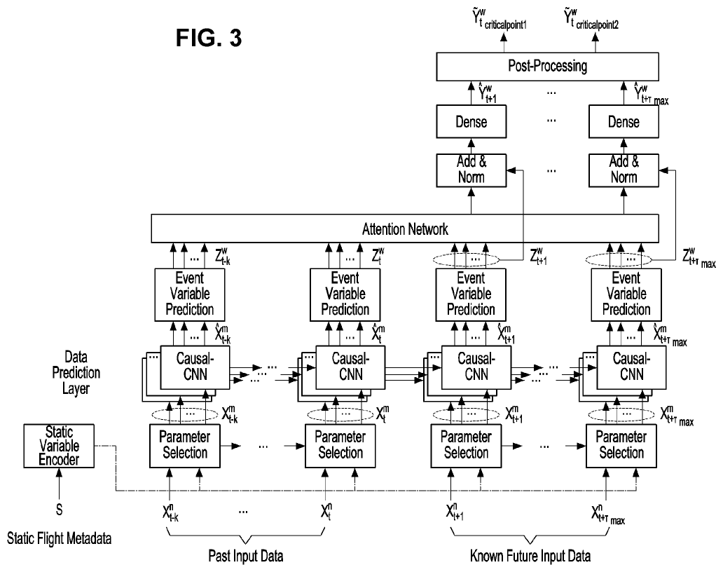

FIG. 3 is a detailed block diagram of the unsafe approach prediction apparatus shown I FIG. 2.

Referring to FIG. 3, the metadata receiving unit 110 of the unsafe approach prediction apparatus may include a static variable encoder. The static variable encoder may receive the static flight metadata denoted by ‘S’ in FIG. 3 and output the static latent variables. The static variable encoder may be implemented by using a deep neural network such as an autoencoder and a variational autoencoder (VAE).

The FDR data extraction unit 120, which may include a status encoder (not shown) and a data set selector (not shown), may extract the past FDR data set, xₜ₋ₖⁿ, . . . , xₜⁿ, and the future FDR data set, xₜ₊₁ⁿ, . . . , x_{τ}_{ₘₐₓ}ⁿ, . . . , x_{τ}_{ₘₐₓ}ⁿ, using the FDR data recorded by the FDR of the aircraft as current status values. The state encoder and data set selector of the FDR data extraction unit 120 will be described below in detail.

The parameter selection unit 130 may select parameters related to the unsafe approaches based on the static latent variables extracted from the static flight metadata and the FDR data sets. The parameter selection unit 130 may include a deep learning network utilizing the softmax function. That is, the parameter selection unit 130 may calculate the probabilities of the parameters corresponding to the importance of respective parameters related to the unsafe approaches by using the softmax function, and may select the m parameters with the highest probabilities that may be used to extract the time series data. For example, the parameter selection unit 130 may extract the parameters, xₜ₋ₖ^{m}, . . . , x_{t+τ}_{ₘₐₓ}^{m}, from the past FDR data set and the future FDR data set.

The time series data output unit 140 may output the time series data for the m parameters selected by the parameter selection unit 130. For example, referring to FIG. 3, the time series data output unit 140 may output the time series data for input data of the (k+1) past FDR data set and the τₘₐₓ future FDR data sets. The time series data output unit 140 may be implemented using a casual convolutional neural network (CNN) or a casual recurrent neural network (RNN). The time series data output unit 140 may receive the parameters, xₜ₋ₖ^{m}, . . . , x_{t+τ}_{ₘₐₓ}^{m}, from the parameter selection unit 130 and output the time series data, \hat{X}ₜ₋ₖ^{m}, . . . , \hat{X}_{τ}_{ₘₐₓ}^{m}.

The event variable selection unit 150 may receive the time series data from the time series data output unit 140 and select the event variable to be used form the unsafe approach determination. For example, the time series data output unit 140 may receive the time series data, \hat{X}ₜ₋ₖ^{m}, . . . , \hat{X}_{τ}_{ₘₐₓ}^{m}, from the time series data output unit 140 and output the time series data, Zₜ₋ₖ^{w}, . . . , Z_{τ}_{ₘₐₓ}^{w}, to which the event variable ‘w’ is applied.

The final prediction data output unit 160 may apply a weight to each of the time series data for the selected event variable and output the final prediction data. Determination and application of the weights may be performed by using an attention layer of the deep neural network. For example, the final prediction data output unit 160 may receive the time series data for the event variable, Zₜ₋ₖ, . . . , Z_{τ}_{ₘₐₓ}^{w}, from the event variable selection unit 150 and determine and applies the weight to each of the time series data for the event variable to output the final prediction data, Ŷₜ₋ₖ^{w}, . . . , Ŷ_{τ}_{ₘₐₓ}^{w}. As a result, the final prediction data output unit 160 may output the final prediction data for future timings, t+1, . . . , t+τₘₐₓ, with respect to the current time.

The unsafe approach determination unit 170 may determine whether the unsafe approach is predicted for the current flight or not based on the final prediction data output by the final prediction data output unit 160. For example, the unsafe approach determination unit 170 may perform the post-processing of the final prediction data, sample the final prediction data at the critical timing corresponding to the value of the specific event variable, and determine the unsafe approach. The critical timing may be a predetermined timing such as the timing when the aircraft is at 500 feet or 1,000 feet above the ground level.

That is, the unsafe approach determination unit 170 may receive the final prediction data, Ŷₜ₋ₖ^{w}, . . . , Ŷ_{τ}_{ₘₐₓ}^{w}, from the final prediction data output unit 160, perform the post-processing, and for determining whether an unsafe approach is output data Ŷₜ_{_{criticalpoint1}}^{w} or Ŷₜ_{_{criticalpoint2}}^{w} predicted or not with respect to the specific time, i.e. the critical point. The critical point 1 may denote a timing when the aircraft is at 500 feet above the ground level, and the critical point 2 may denote a timing when the aircraft is at 1,000 feet above the ground level.

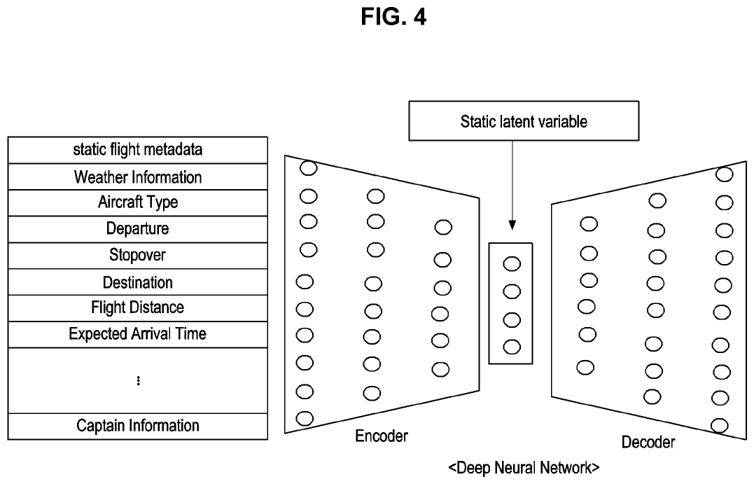

FIG. 4 is a detailed block diagram of the metadata receiving unit 110. In the metadata receiving unit 110 of the unsafe approach prediction apparatus 100, the static variable encoder may receive the static flight metadata and output the static latent variable. As shown in FIG. 4, the static flight metadata may include at least one of the weather information, the aircraft type information, the departure, the destination, the stopover, the flight distance, the expected arrival time, the ATC information, or the captain information of each flight.

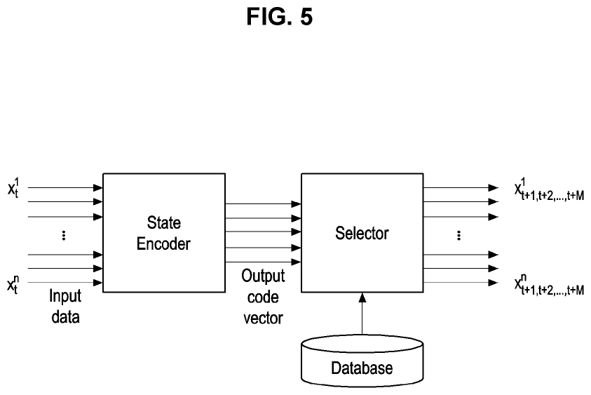

FIG. 5 is a detailed block diagram of the FDR data extraction unit 120. The FDR data extraction unit 120 of the unsafe approach prediction apparatus 100 may include the state encoder and the data set selector. The state encoder may output a code vector by encoding the FDR data being recorded by the FDR of the aircraft as the current state values. For example, the state encoder may generate the code vector by encoding xₜ¹, . . . , xₜⁿ. The data set selector may receive the code vector and extract the FDR data set of M-second intervals in the future, with respect to the current time, expected to be needed for the safe access to the destination of the aircraft. The FDR data set of M-second intervals in the future may be stored in advance in the database. For example, the data set selector may receive the code vector and output an M FDR data sets, X_{t+1,t+2, . . . ,t+M}¹, X_{t+1,t+2, . . . ,t+M}ⁿ.

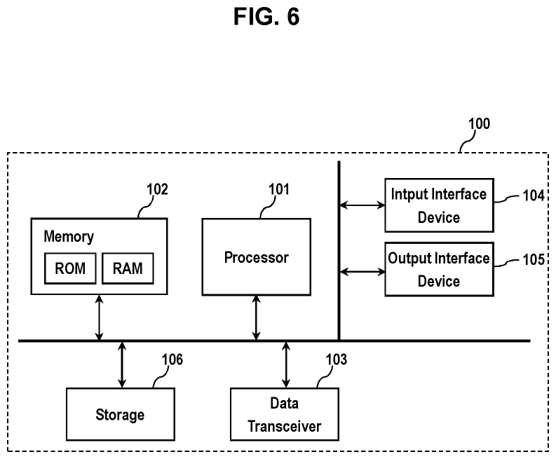

FIG. 6 is a physical block diagram of the unsafe approach prediction apparatus according to an exemplary embodiment of the present disclosure.

The unsafe approach prediction apparatus 100 may include at least one processor 101, a memory 102 storing at least one program instruction to be executed by the processor 101, and a data transceiver 103 performing communications through a network. The unsafe approach prediction apparatus 100 may further include an input interface device 104, an output interface device 105, and a storage 106. The components of the unsafe approach prediction apparatus 100 may be connected by a bus 107 to communicate with each other.

The processor 101 may execute program instructions stored in the memory 102 or the storage 106. The processor 101 may include a central processing unit (CPU), a graphics processing unit (GPU), or may be implemented by another kind of dedicated processor suitable for performing the methods of the present disclosure. The memory 102 may load the program instructions stored in the storage 106 to provide to the processor 101. The memory 102 may include, for example, a volatile memory such as a read only memory (ROM) and a nonvolatile memory such as a random access memory (RAM). The program instructions loaded to the memory 102 may be executed by the processor 101.

The storage 106 may include an intangible recording medium suitable for storing the program instructions, data files, data structures, and a combination thereof. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD).

The storage device 106 may also store data regarding whether an unsafe approach is expected or not that is determined by the unsafe approach prediction method of the present disclosure, along with the various data such as the static flight metadata, the static latent variables, the FDR data sets, the parameters related to the unsafe approaches, the time series data extracted taking into account the parameters related to the unsafe approaches, the event variables, and the final prediction data.

The programs instructions when executed by the processor 101 may cause the processor 101 to receive static flight metadata related to the flight from an external server; extract a flight data recorder (FDR) data set of the aircraft for a safe approach to a destination of the aircraft from history data of flights of the aircraft to the destination stored in advance; select parameters related to unsafe approaches based on the static flight metadata and the FDR data set; extract time series data for the FDR data set taking into account the parameters related to the unsafe approaches; select an event variable to be used for an unsafe approach determination based on the time series data; generate final prediction data by weighting the time series data for the event variable; and determine whether an unsafe approach is predicted or not based on the final prediction data.

The programs instructions that causes the processor 101 to select parameters related to unsafe approaches may include instructions causing the processor 101 to calculate probabilities of parameters corresponding to importance of respective one of the parameters related to the unsafe approaches by using a softmax function, and select the parameters that are expected to be related with the unsafe approaches based on the probabilities.

The programs instructions that causes the processor 101 to determine whether an unsafe approach is predicted or not may include instructions causing the processor 101 to determine whether the unsafe approach is predicted or not at a predetermined timing.

The device and method according to exemplary embodiments of the present disclosure can be implemented by computer-readable program codes or instructions stored on a computer-readable intangible recording medium. The computer-readable recording medium includes all types of recording device storing data which can be read by a computer system. The computer-readable recording medium may be distributed over computer systems connected through a network so that the computer-readable program or codes may be stored and executed in a distributed manner.

The computer-readable recording medium may include a hardware device specially configured to store and execute program instructions, such as a ROM, RAM, and flash memory. The program instructions may include not only machine language codes generated by a compiler, but also high-level language codes executable by a computer using an interpreter or the like.

Some aspects of the present disclosure described above in the context of the device may indicate corresponding descriptions of the method according to the present disclosure, and the blocks or devices may correspond to operations of the method or features of the operations. Similarly, some aspects described in the context of the method may be expressed by features of blocks, items, or devices corresponding thereto. Some or all of the operations of the method may be performed by use of a hardware device such as a microprocessor, a programmable computer, or electronic circuits, for example. In some exemplary embodiments, one or more of the most important operations of the method may be performed by such a device.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of predicting an unsafe approach during an approach phase of a flight, comprising:
receiving static flight metadata related to the flight from an external server;
extracting a flight data recorder (FDR) data set of the aircraft for a safe approach to a destination of the aircraft from history data of flights of the aircraft to the destination stored in advance;
selecting parameters related to unsafe approaches based on the static flight metadata and the FDR data set;
extracting time series data for the FDR data set taking into account the parameters related to the unsafe approaches;
selecting an event variable to be used for an unsafe approach determination based on the time series data;
generating final prediction data by weighting the time series data for the event variable; and
determining whether an unsafe approach is predicted or not based on the final prediction data.

2. The method of claim 1, wherein the static flight metadata comprises at least one of weather information, aircraft type information, a departure, a destination, a stopover, a flight distance, an expected arrival time, air traffic control (ATC) information, or captain information of the flight.

3. The method of claim 1, wherein the FDR data set comprises a preset number of past FDR data sets and a preset number of future FDR data sets on a basis of a current time for the aircraft.

4. The method of claim 1, wherein selecting parameters related to unsafe approaches comprises:
calculating probabilities of parameters corresponding to importance of respective one of the parameters related to the unsafe approaches by using a softmax function; and
selecting the parameters that are expected to be related with the unsafe approaches based on the probabilities.

5. The method of claim 1, wherein the event variable comprises at least one of heading and pitch, a speed, a configuration, a descent rate, an airspeed, a glide slope, a latitude, a longitude, or an altitude of the aircraft.

6. The method of claim 1, wherein determining whether an unsafe approach is predicted or not comprises:
determining whether the unsafe approach is predicted or not at a predetermined timing.

7. The method of claim 1, wherein the predetermined timing comprises a time when the aircraft is at 500 feet or 1,000 feet above ground level.

8. An apparatus for predicting an unsafe approach during an approach phase of a flight, comprising:
a processor; and
a memory storing at least one instruction to be executed by the processor,
wherein the at least one instruction when executed by the processor causes the processor to:
receive static flight metadata related to the flight from an external server;
extract a flight data recorder (FDR) data set of the aircraft for a safe approach to a destination of the aircraft from history data of flights of the aircraft to the destination stored in advance;
select parameters related to unsafe approaches based on the static flight metadata and the FDR data set;
extract time series data for the FDR data set taking into account the parameters related to the unsafe approaches;
select an event variable to be used for an unsafe approach determination based on the time series data;
generate final prediction data by weighting the time series data for the event variable; and
determine whether an unsafe approach is predicted or not based on the final prediction data.

9. The apparatus of claim 8, wherein the static flight metadata comprises at least one of weather information, aircraft type information, a departure, a destination, a stopover, a flight distance, an expected arrival time, air traffic control (ATC) information, or captain information of the flight.

10. The apparatus of claim 8, wherein the FDR data set comprises a preset number of past FDR data sets and a preset number of future FDR data sets on a basis of a current time for the aircraft.

11. The apparatus of claim 8, wherein the instruction that causes the processor to select parameters related to unsafe approaches comprises instructions causing the processor to:
calculate probabilities of parameters corresponding to importance of respective one of the parameters related to the unsafe approaches by using a softmax function; and
select the parameters that are expected to be related with the unsafe approaches based on the probabilities.

12. The apparatus of claim 8, wherein the event variable comprises at least one of heading and pitch, a speed, a configuration, a descent rate, an airspeed, a glide slope, a latitude, a longitude, or an altitude of the aircraft.

13. The apparatus of claim 8, wherein the instruction that causes the processor to determine whether an unsafe approach is predicted or not comprises instructions causing the processor to:
determine whether the unsafe approach is predicted or not at a predetermined timing.

14. The apparatus of claim 13, wherein the predetermined timing comprises a time when the aircraft is at 500 feet or 1,000 feet above ground level.
